(19) United States
(12) Patent Application Publication
(10) Pub. No.: US 2002/0160677 A1
(43) Pub. Date: Oct. 31, 2002

(54) Flexible multilayer flat material with reinforced cover layer

(76) Inventors: Karin Ulrike Loffler, Esslingen (DE); Hansjorg Mauk, Mundelsheim (DE); Bernhard Jung, Weinsberg (DE); Heinz V. Olnhausen, Bietigheim-Bissingen (DE); Siegfried Reichert, Erligheim (DE)

Correspondence Address: Womble Carlyle Sandridge & Rice, PLLC, P.O. Box 7037, Atlanta, GA, 30357-0037, US

(21) Appl. No.: 09/814,908

(22) Filed: Mar. 22, 2001

Related U.S. Application Data
(63) Continuation of application No. 09/719,326.
Application No. 09/719,326 is a 371 of international application No. PCT/EP99/04419, filed on Jun. 25, 1999.

(30) Foreign Application Priority Data
Jun. 26, 1998 (DE) 198 28 676.7

(51) Int. Cl. B32B 17/02; B32B 17/04

(52) U.S. Cl. 442/180; 442/394; 428/304.4

(57) ABSTRACT

Disclosed is a flexible multilayer flat material which contains at least one wear layer and/or cover layer having at least one flat reinforcement material located in it. In particular, the invention concerns a flexible multilayer flat material comprising at least one cover layer, with at least one flat reinforcement material, preferably a nonwoven material, embedded in the cover layer. On one hand, the reinforcement material provides the multilayer flat material with improved mechanical properties, such as tensile strength and/or resilience, and, on the other hand, the reinforcement material simultaneously allows the decoration of such flat materials in its function as a printable image carrier.

### DESCRIPTION

The present invention concerns a flexible multilayer flat material which contains at least one wear layer and/or cover layer having at least one flat reinforcement material located in it. In particular, the invention concerns a flexible multilayer flat material comprising at least one cover layer, with at least one flat reinforcement material, preferably a nonwoven material, embedded in the cover layer. On one hand, the reinforcement material provides the multilayer flat material with improved mechanical properties, such as tensile strength and/or resilience, and, on the other hand, the reinforcement material simultaneously allows the decoration of such flat materials in its function as a printable image carrier.

Flat materials based on natural and/or artificial materials which have a predetermined color pattern are well known and are extensively used as wall, ceiling, and floor coverings, and as decorative films or artificial veneers. In particular, these types of patterned flat materials based on natural and/or artificial materials are used as flexible floor coverings. Such flat materials based on natural and/or artificial materials are typically produced by premixing all components, e.g. polymeric binders, colorants, fillers, additives, processing aids, and other auxiliary materials, and plastifying and granulating them via aggregates, e.g. internal mixers, twin screw extruders, and planetary roller extruders. The granulated particles are subsequently pressed into a web or a plate in compression aggregates, e.g. calenders, double belt presses, or stationary presses. The granulates used are typically multicolored. In this type of floor covering (homogenous floor coverings), patterning is thus only achieved via the stochastic distribution of the multicolored granulates by means of distortion, for example on calendars, or by means of compression. Such coverings are consequently not printed.

CV floor coverings (cushion vinyls) are currently widely used due to, among other things, their multiple decorative possibilities. To produce such CV floor coverings, PVC plastisols are typically applied to a carrier layer in a coating process and subsequently gelled. The plastisols hereby consist of PVC particles, plasticizers, stabilizers, and typical auxiliary materials and fillers, which sinter together to a matrix in the gelling oven. The plastisol layer can hereby, as the image carrier, be provided with multicolor gravure printing for appropriate decorative design and/or patterning of the covering. In addition to further advantageous properties, the possibility of partial inhibition for production of surface texturing in the course of the chemical foaming has, in particular, ensured the wide dissemination of such materials. The partial inhibition of the expansion of the chemical foaming agent and thereby the production of a relief-like structure of the cover layer and/or the cover coating is hereby produced through the addition of an inhibitor to the printing inks used for the colored patterning. Various relief depths are attained through variation of the amount of inhibitor used. The patterning of surfaces through the partial inhibition of such a foaming process is, however, only applicable in those cases in which the design of the corresponding flat material provides a foam layer.

The patterning and/or texturing of the surfaces of floor coverings can also be performed according to the prior art by embossing the surfaces with the aid of embossing rolls. This type of process can, however, only be used if the coating compound which forms the covering and/or wear layer of the corresponding flat material is not duroplastic.

The CV floor coverings, however, generally require a relatively large amount of covering layer material in order to ensure protection of the colored design, as otherwise the thin color layer wears off relatively quickly. Furthermore, the imprinting properties of such CV coverings are not always sufficient.

It is therefore the task of the current invention to provide a flexible multilayer flat material that is to have excellent material properties, such as mechanical tensile strength and/or resilience, on one hand, and is to simultaneously allow a variable decorative design while retaining a permanent pattern with predetermined color and shape and significantly reducing costs on the other hand. In particular, the patterning possibilities in the production of such a flat material should be such that technologically costly mixing, metering, and supplementary processes which occur in typical production methods can be dispensed with. This task is solved by the embodiments characterized in the claims. In particular, a flexible multilayer flat material is provided which comprises at least one cover layer having at least one flat reinforcement material positioned in it. The expression that the cover layer has at least one flat reinforcement material positioned in it should be understood to mean, among other things, that a layer of the reinforcement material is embedded essentially over the entire area of the cover layer, and/or that the reinforcement material is completely surrounded by the coating compound and/or polymeric binders constituting the cover layer, so that a closed layer is formed around the reinforcement material. The reinforcement material can hereby be positioned at any level of the cover layer, provided that it is completely surrounded and/or impregnated by the coating compound constituting the cover layer.

The reinforcement material is preferably selected from the group of nonwoven materials. The nonwoven material can be a wet nonwoven material, a dry nonwoven material, or a spunbonded nonwoven material. In a preferred embodiment of the present invention, the nonwoven material used as the reinforcement material is a cellulose nonwoven material.

The nonwoven material located as reinforcement material in the cover layer of the flat material according to the invention preferably has a weight in the range from 9 to 50 g/m².

In one embodiment of the present invention, the nonwoven material is printed and/or provided with printing. This printing can, for example, be a possibly colored pattern or image. The nonwoven material embedded and/or located in the cover layer according to the invention thereby acts not only as a reinforcement material, but can also be an image carrier. In addition, this type of image carrier can advantageously be printed in the primary color space. Flexible letterpress or inkjet printing is particularly suitable for the printing of the nonwoven material and/or nonwoven layer used as reinforcement material in the flat material according to the invention, and is, in addition, very favorably priced. A livelier image can hereby be produced in comparison to printing in the special color space, wherein the colors must first be premixed. If several printed layers of the preceding nonwoven material are used, decorative 3-D effects can, for example, also be attained through appropriate harmonization.

The thickness of the cover layer of the multilayer flat material according to the invention is preferably at least 90 μm.

Any material which is suitable for the production of webs or plates, particularly for elastic floor coverings, can be used as the polymeric binder and/or coating compound for the cover layer of the flat material according to the invention. Coating compounds selected from the group of plastisols, dispersions, organosols, and lacquers will preferably be used for the cover layer.

For example, plastics based on polyvinyl chloride (PVC), ethylene vinyl acetate copolymer (EVA), homopolymers or copolymers of ethylenic unsaturated compounds, or a mixture of these, such as polyethylene, polypropylene, possibly with one or more comonomers, ethylene alkyl acrylate copolymers, and mixtures of these could be used for the cover layer. Furthermore, terpolymers, such as ethylene propylene diene mixed polymers (EPDM), block copolymers, such as styrene isoprene styrene (SIS), and styrene butadiene styrene (SBS) could be used. Of the binders mentioned, PVC is preferred.

Coating compounds based on renewable raw materials could also be used for the cover layer. In particular, a material containing a polyreaction product could be used as the coating compound for the cover layer, whereby the polyreaction products can be obtained by reaction of at least one dicarboxylic acid or polycarboxylic acid or their derivatives or a mixture of these with at least one epoxidation product of a carboxylic acid ester or a mixture of these epoxidation products and simultaneous or subsequent curing of the reaction product.

The reaction and/or curing of these reaction products is hereby essentially performed with

(a) UV radiation in the presence of at least one UV initiator and/or

(b) electron beam radiation possibly in the presence of at least one UV initiator and/or

(c) IR radiation and/or

(d) thermal.

The UV initiators could be radical or cationic UV initiators or a mixture of these UV initiator types. Preferred examples of radical UV initiators are benzophenone, benzophenone derivatives, phosphine oxides, α-morpholinoketones, quinone, quinone derivatives, or α-hydroxyketones, or mixtures of these. Preferred examples of cationic UV initiators are triarylsulfonium salts, which could be of one type or be present as a mixture of various triarylsulfonium salts, or diaryliodonium salts, or a mixture of these. The UV initiators are, for example, present in a quantity of up to 8 weight percent, preferably 0.1 to 3 weight percent, depending on the quantity of the material containing the reaction products.

In addition to the UV initiator, at least one photosensitizer, such as, for example, compounds based on anthracene, perylene, or thioxanthene-9-one can be present which activates the UV initiator and can amplify its effect. The concentration of the UV initiator can hereby be reduced. The UV radiation used lies within the typical range, i.e. between 200 nm and 380 nm. The IR radiation used lies within the typical range, e.g. 760 nm to 0.5 mm.

The dicarboxylic acids or polycarboxylic acids and/or their derivatives preferably contain at least one double bond per molecule.

Maleic acid, itaconic acid, fumaric acid, succinic acid, methyl succinic acid, malic acid, or furan dicarboxylic acid or a mixture containing at least two of these acids can preferably be used as the dicarboxylic acid. Acids with three or more carboxylic acid groups, for example citric acid and aconitic acid, can preferably be used as the polycarboxylic acid.

Anhydrides or partial esters or derivatives having at least one free carboxylic acid group can be used as derivatives of the dicarboxylic acids or polycarboxylic acids. The alcohol components of the partial ester are not subject to any particular restrictions, however, polyols such as dipropylene glycol, propane diols, butane diols, hexane diols, hexane triols, glycerin, or pentaerythrite or a mixture containing at least two of these polyols are preferably used as the alcohol components.

In a particularly preferred embodiment, a mixture of a partial ester of maleic acid anhydride and dipropylene glycol is used as a cross-linker together with citric acid, whereby the proportion of citric acid is up to 50 weight percent, more preferably up to 25 weight percent, depending on the total amount of cross-linker.

The epoxidation product preferably contains more than one epoxy group per molecule. Epoxidized linseed oil, epoxidized soybean oil, epoxidized caster oil, epoxidized rapeseed oil or vernonia oil or a mixture containing at least two of these epoxidized products can preferably be used as the epoxidation product of a carboxylic acid ester. The previously defined alcohols of the partial esters, such as dipropylene glycol, propane diols, butane diols, hexane diols, hexane triols, or pentaerythrite or a mixture containing at least two of these polyols could also preferably be used as the alcohol components of this carboxylic acid ester. The carboxylic acid components are not subject to any particular restrictions.

Furthermore, the coating compound could contain at least one further additive, consisting of, for example, fillers, pigments for patterning, expanding agents and/or foaming agents, hydrophobification agents, and auxiliary materials.

The fillers for the previously mentioned coating compounds are preferably wood flour, chalk, cork flour, barium sulfate (“heavy spar”), slate flour, silicic acid, kaolin, quartz flour, talcum, lignin, cellulose, glass, textile, glass, or plant fibers, cellulose fibers, polyester fibers, or for example, colored granulate and/or chips from the preceding material containing polyreaction products, or a mixture containing at least two of these materials. Wood flour, chalk, cellulose, lignin, or cork flour, or a mixture containing at least two these fillers is particularly preferred as a filler. The proportion of filler relative to the total amount of the corresponding coating compound is preferably 15 to 80 weight percent.

Tall oil, synthetic or natural resins, such as balsamic resin, copal resin, hydrocarbon resins, and/or siccatives, such as compounds of the metals Al, Li, Ca, Fe, Mg, Mn, Pb, Zn, Zr, Ce, or Co, or a combination containing at least two these compounds could be used as auxiliary materials for the coating compounds, particularly the material containing polyreaction products. If necessary, antioxidants, UV stabilizers, and further typical auxiliary materials, e.g. lubricants, antistatics, or processing aids, could be added to the components from which the corresponding coating compounds are produced. These auxiliary materials are well known in and of themselves in this technical field.

In a preferred embodiment, the cover layer of the flat material according to the invention is transparent. In this case, the corresponding coating compound for the cover layer contains no more than two weight percent of filler. Similarly to the “oil spot phenomenon,” a transparent development of the cover layer leads to the image printed on the embedded nonwoven material being clearly visible, while the fiber structure of the nonwoven is barely optically perceptible.

The flat material according to the invention can be used in many applications, preferably as a wall, ceiling, or floor covering, a decorative film, or an artificial veneer. Utilization as a floor covering is particularly preferable.

The flat material according to the invention can be applied to a carrier material. Any material based on natural and/or synthetic films, fabrics, scrims, nonwovens, or knit fabrics, as well as textile materials, can be used as the carrier. In particular, carrier materials used for carrier-reinforced floor coverings could be used. Examples of these are jute fabric, mixed fabrics made of natural fibers, such as cotton and spun rayon, glass fiber fabrics, glass fiber fabrics coated with bonding agents, mixed fabrics made of synthetic fibers, and fabrics made of cladded core fibers with, for example, a core of polyester and a cladding of polyamide. A coating of the glass fibers made of a styrene butadiene latex can, for example, be used as the bonding agent for glass fiber fabrics. In principle, however, all materials suited for this purpose could be considered as carriers for the flat material, e.g. particle board, HDF, MDF, and LDF [high, middle, and low density fiberboard] plates (i.e. particle or fiber board with high, medium, or low compression), inorganic plates (e.g. gypsum plasterboard), etc.

In a preferred embodiment, one or more flat nonwoven materials can be located under the cover layer. These nonwoven materials located under the cover layer could be the same as or different from the nonwoven material located and/or embedded in the cover layer as reinforcement material. The nonwoven material layer located under and/or laminated onto the cover layer is preferably a glass fiber nonwoven material. This arrangement of reinforced cover layer with a nonwoven material layer laminated onto it has particularly advantageous mechanical properties.

In another preferred embodiment of the present invention, a flexible multilayer flat material is provided, made of at least one carrier layer (I) and at least one previously defined cover layer (II), possibly one backing coating (III) located under the carrier layer (I) made of a chemically or mechanically foamed foam layer, and possibly a compact or base coating (IV), which is positioned between the carrier layer (I) and cover layer (II) and/or between the carrier layer (I) and back coating (III), whereby the coating compounds for the layers (III) and (IV) are based on one of the previously described materials.

The coating compounds for the flat material according to the invention can all contain larger amounts of filler, whereby in the compact coating preferably 10 to 60 weight percent, particularly 30 weight percent, of filler is used, and in the chemical foam, 20 to 65 weight percent, preferably 35 weight percent, of filler is used, while the compounds for the mechanical foam usually only contain a small amount, preferably not more than 10 weight percent, e.g. 1 to 10 weight percent, more preferably not more than 5 weight percent, of filler. All percent amounts are always relative to the total amount of the coating compounds, for example the preceding material containing reaction products, if not otherwise noted.

The coverings contain relatively large proportions of additives, particularly mineral fillers from the group including chalk, barium sulfate, silicic acid, kaolin, and talcum, and if necessary, however, also wood flour, cork flour, glass flour, cellulose, lignin, textile fibers, or plant fibers, which could also be present in the mixture, whereby the amount of filler in the overall floor covering can be up to 70 weight percent, in foam-free coverings preferably 30 to 60 weight percent, and in floor coverings with chemically foamed layers, preferably 40 to 60 weight percent of the overall floor covering.

The flat materials according to the invention, i.e., for example, floor coverings or tiles, will, if the previously defined material containing polyreaction products is used for assembly of the cover layer (II) surrounding the reinforcement material as well as the further layers (III) and (IV), be produced in such a way that, for example, a combination of the previously defined dicarboxylic or polycarboxylic acids and/or their derivatives and epoxidation products in a weight ratio of 1:0.3 to 1:8, particularly 1:0.5 to 1:3, 1:0.6 to 1:1.2 and 1:1 to 1:4, fillers, and, in the compound for the cover coating, possibly a hydrophobification agent, and, in the coating for a chemical foam, an expanding agent, and, if necessary, a foam stabilizer for each foam compound, are mixed and processed into a paste and this paste is then processed into multilayer floor coverings.

In compounds for chemically foamed layers, the amount of expanding agent lies in the typical range up to approximately 15 weight percent, whereby the amount of other typical auxiliary agents can range up to approximately 15 weight percent.

The floor covering preferably consists of three, four, or five layers, for example a simple design with the carrier, the reinforced cover layer, and a protective layer, or a design with a compact coating, possibly a chemical foam coating, and a transparent reinforced cover layer, and a carrier coating, and, if necessary, a chemically foamed backing coating, whereby the chemical foam could also, of course, be replaced by a mechanical foam or both types of foam could be present. In a particular embodiment of the invention, if a chemically foamed layer (V) is positioned between the compact coating and the reinforced transparent cover layer, this foam layer can be colored by the addition of appropriate colorants, such as pigments, in such a way that a colored decorative background for the image and/or pattern which is printed on the nonwoven material located in the cover layer is formed. Of course, the compact coating can also be colored for this purpose. The foamed layer (V) can also include the preferably UV-cured material containing polyreaction products previously defined. For this purpose, a paste is applied to the compact coating. This paste contains an expanding agent and a kicker; these include polyols, urea, and zinc, lead, or cadmium compounds, whereby ZnO, which lowers the decomposition temperature of the expanding agent, is preferred. The paste coating is then cross-linked below the decomposition temperature of the expanding agent, whereby if necessary an inhibitor is added. The inhibitor weakens the effect of the kicker or removes it completely, so that the decomposition of the expanding agent is displaced to higher temperatures. Suitable substances with inhibitory effect are, for example, benzotriazole derivatives, trimellitic acid anhydride, and similar substances. Various relief depths can be achieved through variations of the amount of inhibitor added. A protective layer (VI) made of polymers and/or copolymers or waxes can be located over this chemically foamed layer with applied relief pattern and the cover layer lying over it. Examples of these unsaturated curable lacquer systems are polyacrylates, polymethacrylates, polyurethanes, and mixtures of these. However, Carnauba wax, for example, can also be used. The protective layer is to be produced from (co)polymers which are compatible with the cover layer.

A further object of the present invention is a process for production of the flat material previously described, which comprises the application of the material constituting the cover layer onto one or more possibly printed flat reinforcement materials, particularly nonwoven materials, in such a way that the reinforcement material is thereby completely impregnated, and the subsequent hardening of this material for production of the cover layer, and the application of this type of cover layer to a carrier.

This particularly concerns a continuous process which, similarly to CV production, features an overall construction of a floor covering by sequential application of various pastes. This type of process can also, as already mentioned, include foaming, particularly chemical foaming, in addition to the insertion of the reinforcement material in the cover layer.

The production of the flat material according to the invention is performed, for example, by mixing the components to a paste, applying them in an appropriate thickness to a web by means of coating devices, foaming them if necessary, and, depending on the selection of the coating compound, hardening them in an appropriate way. Layers which contain foaming agent and layers which do not contain foaming agent can also be attached to the web and foamed and bonded in simultaneous or sequential steps.

In a further preferred embodiment, one or more further flat nonwoven materials can be located under the cover layer before the hardening of the cover layer. For this purpose, the previously described reinforced cover layer is combined in a typical lamination process with one or more flat nonwoven materials, which can be the same as or different from the nonwoven material located and/or embedded in the cover layer as reinforcement material, in such a way that the cover layer is bound to the further nonwoven material. For example, a printed and/or unprinted cellulose nonwoven material is coated with transparent PVC plastisol on a coating device and laminated together with unprinted glass fiber nonwoven material. In a second work cycle, a backing coating is subsequently applied to the rear side of the glass fiber nonwoven material, pressed onto the front side of the transparent plastisol by means of screen printing as a surface texture, and subsequently gelled in the channel. Patterning of the surface can also be produced through embossing.

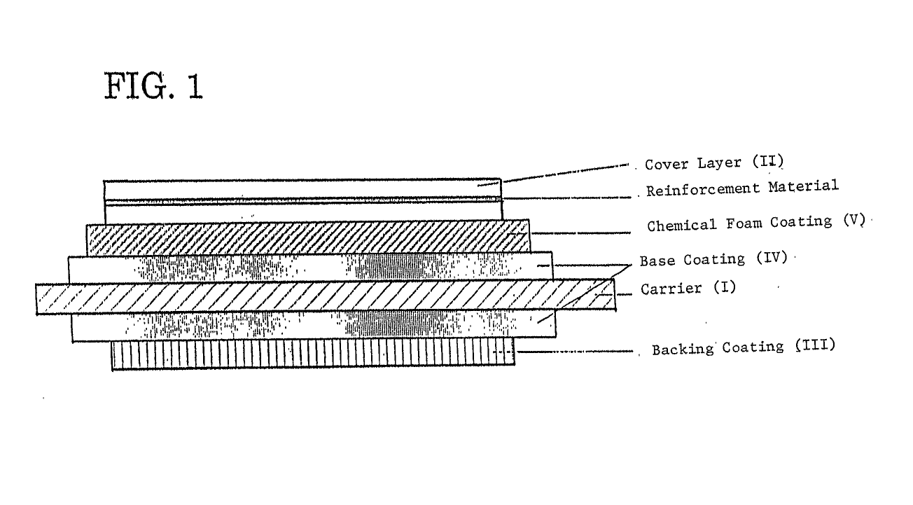

FIG. 1 shows a preferred embodiment of the flat material according to the invention with a carrier (I) having a base coating (IV) on both sides, a backing coating (III) located below this, a chemical foam coating (V) located on the upper base coating, and a cover layer (II) located above this, which then has a layer of nonwoven material embedded in it as reinforcement material.

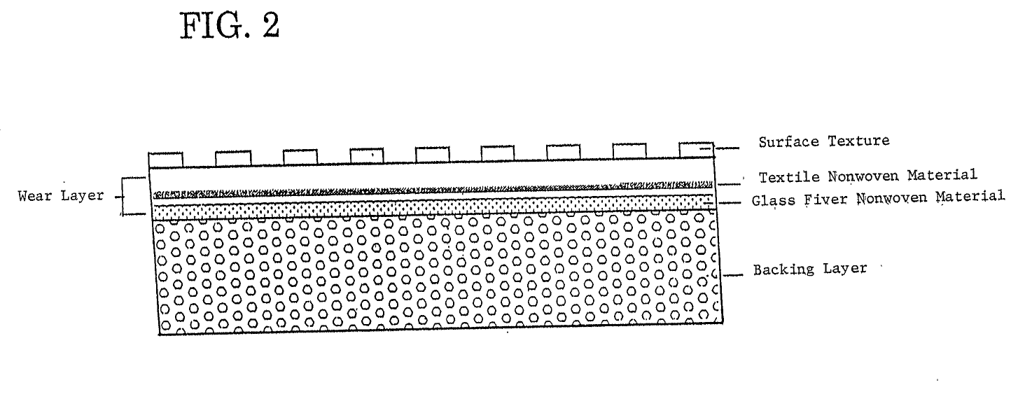

FIG. 2 shows a preferred embodiment of the flat material according to the invention with a cover coating surface textured through screen printing having a possibly printed nonwoven material embedded in it, a glass fiber nonwoven material laminated onto this, and a backing coating located under the glass fiber nonwoven material made of a chemically or mechanically foamed foam layer.

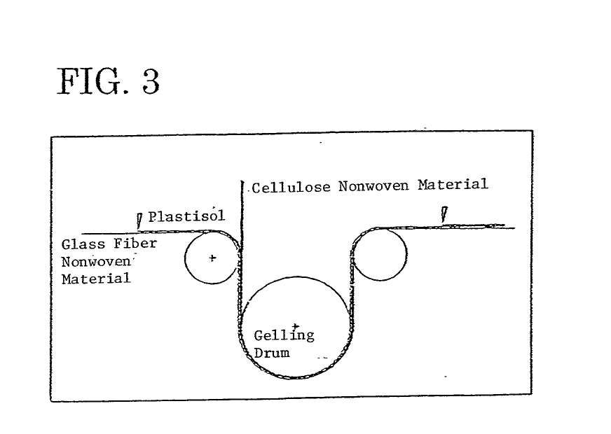

FIG. 3 shows a schematic depiction of a preferred embodiment for production of the flat material according to the invention, wherein a printed and/or unprinted cellulose nonwoven material is coated with transparent PVC plastisol and laminated together with an unprinted glass fiber nonwoven material in a first work cycle.

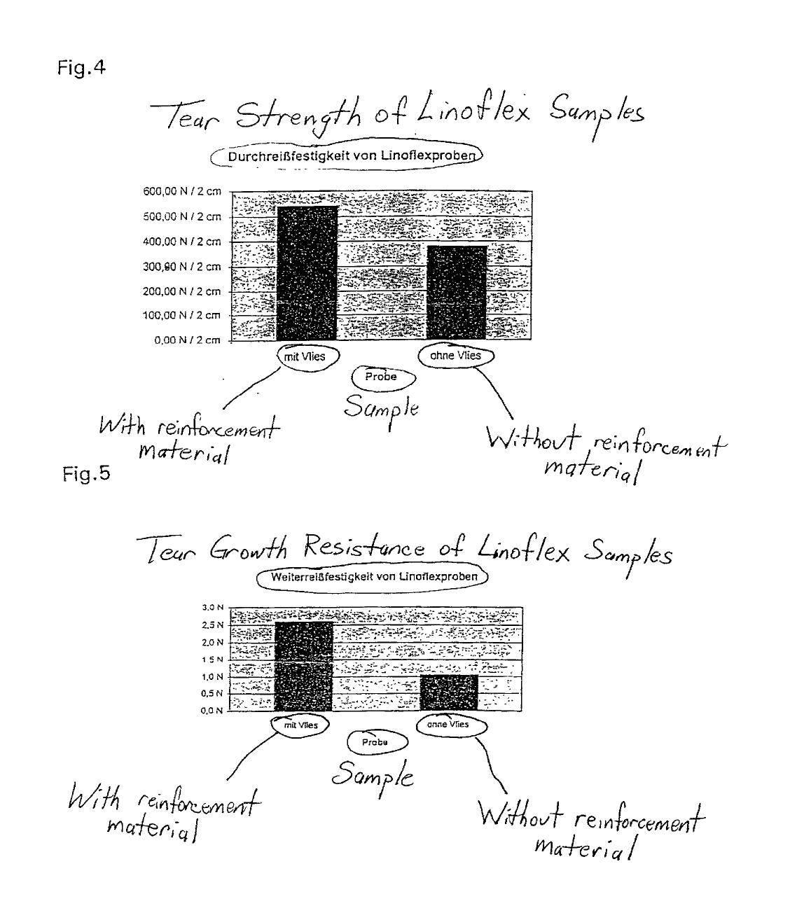

FIG. 4 shows the results in regard to tear strength of two different samples as produced in the following example.

FIG. 5 shows the results in regard to tear growth resistance of two different samples as produced in the following example.

The following example illustrates the invention.

### EXAMPLE

Two cover layers based on the previously defined material containing polyreaction products (“Linoflex cover layers”) with a thickness of 300 μm were applied to 0.4 mm thick paperboard. In one sample, a 23 g cellulose nonwoven material was additionally laminated on. Both samples were subsequently cured at 180° C. and a dwell time of 6 minutes.

Formulation of the Linoflex cover layer:

| | | |
|---|---|---|
| Epoxidized linseed oil | 51.00 | g |
| Microdispersed succinic | 2.00 | g |
| acid | | |
| PMMA | 3.00 | g |
| Linseed oil | 2.00 | g |
| Partial ester of dipropylene | 25.00 | g |
| glycol and maleic acid | | |
| Siccative | 1.10 | g |

The tear strength and tear growth resistance were subsequently measured on 2 cm thick strips of both samples. The results are indicated in FIGS. 4 and 5 in block diagrams.

The diagrams depicted in FIGS. 4 and 5 indicate that in comparison to the nonreinforced sample, the sample in which the cellulose nonwoven material layer is located in the cover layer provides distinctly improved values in regard to tear strength and tear growth resistance.

1. Flexible multilayer flat material comprising at least one cover layer having at least one flat reinforcement material positioned in it.

2. Flat material according to claim 1, whereby the reinforcement material is selected from the group of nonwoven materials.

3. Flat material according to claim 2, whereby the nonwoven material is a wet nonwoven material, a dry nonwoven material, or a spunbonded nonwoven material.

4. Flat material according to claim 3, whereby the nonwoven material is a cellulose nonwoven material.

5. Flat material according to one of the claims 1 to 4, whereby the nonwoven material is printed.

6. Flat material according to one of the claims 1 to 5, whereby the nonwoven material has a weight in the range from 9 to 50 g/m².

7. Flat material according to one of the claims 1 to 6, whereby the thickness of the cover layer is at least 90 μm.

8. Flat material according to one of the claims 1 to 7, whereby the coating compound for the cover layer is based on a material selected from the group of plastisols, organosols, dispersions, or lacquers.

9. Flat material according to claim 8, whereby the plastisol is a PVC plastisol.

10. Flat material according to claim 8, whereby the coating compound for the cover layer is a material containing polyreaction products, whereby the polyreaction products can be obtained by the reaction of at least one dicarboxylic acid or polycarboxylic acid or their derivatives or a mixture of these with at least one epoxidation product of a carboxylic acid ester or a mixture of these epoxidation products.

11. Flat material according to claim 10, whereby the dicarboxylic acid is maleic acid, itaconic acid, fumaric acid, succinic acid, methyl succinic acid, malic acid, or furan dicarboxylic acid or a mixture containing at least two of these acids.

12. Flat material according to claim 10, whereby the polycarboxylic acid is selected from citric acid or aconitic acid

13. Flat material according to one of the claims 10 to 12, whereby the derivative of the dicarboxylic acid or polycarboxylic acid is an anhydride or partial ester.

14. Flat material according to claim 13, whereby the alcohol component of the partial ester is a polyol.

15. Flat material according to claim 14, whereby the polyol is dipropylene glycol, a propane diol, a butane diol, a hexane diol, a hexane triol, glycerin, or pentaerythritol, or a mixture containing at least two of these polyols.

16. Flat material according to one of the preceding claims 10 to 15, whereby the mixture of at least one dicarboxylic acid or polycarboxylic acid or their derivatives is a mixture of a partial ester of maleic acid anhydride and dipropylene glycol with citric acid

17. Flat material according to one of the claims 10 to 16, whereby the epoxidation product of a carboxylic acid ester contains more than one epoxy group per molecule.

18. Flat material according to one of the claims 10 to 17, whereby the epoxidation product of a carboxylic acid ester is epoxidized linseed oil, epoxidized soybean oil, epoxidized caster oil, epoxidized rapeseed oil or vernonia oil or a mixture containing at least two of these epoxidation products.

19. Flat material according to one of the claims 10 to 18, whereby the cover layer additionally contains one or more fillers.

20. Flat material according to one of the claims 1 to 19, whereby the cover layer (II) is transparent.

21. Flat material according to claim 20, whereby no more than 2 weight percent of filler is contained in the coating compound for the cover layer.

22. Flat material according to one of the claims 1 to 21, whereby one or more flat nonwoven materials are additionally located under the cover layer.

23. Flat material according to claim 22, whereby the nonwoven material located under the cover layer is a glass fiber nonwoven material.

24. Flat material according to one of the preceding claims made of at least one carrier layer (I) and at least one previously defined cover layer (II), possibly one backing coating (III), located under the carrier layer (I), made of a chemically or mechanically foamed foam layer, and possibly a compact or base coating (IV), which is positioned between the carrier layer (I) and cover layer (II) and/or between the carrier layer (I) and backing coating (III), whereby the coating compounds for the layers (III) and (IV) are based on a material according to one of the claims 8 to 19.

25. Flat material according to claim 24, whereby a protective layer (VI) of unsaturated curable lacquer systems is located over the cover layer (II), whereby the polymers or copolymers for the lacquer systems are selected from the group consisting of polyacrylates, polymethacrylates, polyurethanes, and mixtures of these.

26. Process for the production of a flexible multilayer flat material according to one of the claims 1 to 25, comprising the application of the material constituting the cover layer on one or more, possibly printed, flat nonwoven materials in such a way that the nonwoven material is completely impregnated, and the subsequent hardening of this material for production of the cover layer, and the application of this type of cover layer to a carrier.

27. Process according to claim 26, whereby one or more flat nonwoven materials are additionally located under the cover layer before the hardening of the cover layer.
